(19) United States
(12) Patent Application Publication
(10) Pub. No.: US 2007/0234123 A1
(43) Pub. Date: Oct. 4, 2007

(54) Method for detecting switching failure

(75) Inventors: Wh Shih, Taipei (TW); Chin-Fong Pan, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/394,702

(22) Filed: Mar. 31, 2006

(51) Int. Cl. G06F 11/00

(52) U.S. Cl. 714/36

(57) ABSTRACT

A method for detecting a switching failure, applied to a system having a Base Management Controller (BMC), a BIOS and a CPU under an Intelligent Platform Management Interface (IPMI), so as to avoid failure when the BMC switches from a Fault Resilient Booting (FRB) 3 mechanism to a FRB 2 mechanism. The method at includes the steps of allowing the BMC to perform the FRB 3 mechanism when power-on of the system is detected; canceling the FRB 3 mechanism by the BMC after the BIOS code is obtained by the CPU and starting a timing process for counting a predetermined time; and if the BIOS sends a command to the BMC within the predetermined time to enable the FRB 2 mechanism for monitoring a Power On Self Test (POST) performed by the BIOS, the BMC disabling the self-generated timing process, otherwise establishing and storing a failure record.

### FIELD OF THE INVENTION

The present invention relates to a method for detecting a switching failure, and more particularly, to a method for detecting failure during switching from a Fault Resilient Booting (FRB) 3 mechanism to a FRB 2 mechanism defined under an Intelligent Platform Management Interface (IPMI) architecture.

### BACKGROUND OF THE INVENTION

Along the rapid development of computer technology, processing power of computers increases tremendously. Development in network technology has also facilitated communication between computers, such that a computer at a terminal can successfully and quickly access information in a computer at another remote terminal, achieving information exchange between various different locations.

For example, blade servers emerge as a result of combining computer and network technologies. The employment of blade servers enhances efficiency of network management. In order to utilize blade servers to their full extent, manufacturers of servers, network or computers have researched and developed various kinds of management interfaces, such as Intelligent Platform Management Interface (IPMI) technology. IPMI technology is developed to be compliant with a Base Management Controller (BMC) provided on each server unit in the blade server to increase data transmission efficiency of each BMC.

Furthermore, when booting each server unit in the blade server, a Power-On Self Test (POST) similar to that performed by a standard computer will be performed. For the blade server to perform the POST, each server unit performs initialization via communication between chips such as the BMC and a CPU. Thus, in order for the CPU to identify the status of BMC during POST, two fault resilient mechanisms are defined under IPMI architecture, that is, Fault Resilient Booting (FRB) 2 and 3.

Generally speaking, once the blade server is turned on and supplies power to the BMC, the BMC enables the FRB 3 mechanism. Upon reading a BIOS code, BMC disables the FRB 3 mechanism. Thereafter, the CPU performs the POST task according to the BIOS program, that is, a command is given to the BMC, so as to notify the BMC that the blade server is now performing the POST task. Meanwhile, the BMC enables the FRB 2 mechanism to perform initialization for peripheral elements; disables the FRB 2 mechanism when initialization is completed. Using these two FRB 2 and FRB 3 mechanisms, the CPU is able to identify the status of the BMC during the POST.

However, when switching from the FRB 3 mechanism to the FRB 2 mechanism, there is a period during which a fault will not be detected, that is, when the FRB 3 mechanism is cancelled and the FRB 2 mechanism is entered, the FRB 2 mechanism has to carry out a memory detection command, if a system fault occurs during this period, it will not be recorded by the system, and there will be no response, such that the system has to be restarted. In addition, an engineer will not be able to determine the problem and make maintenance accordingly. However, a fault is generated based on the condition of software and hardware in cooperation at that instance, it will not occur every time the FRB 3 mechanism is switched to the FRB 2 mechanism. Such uncertainty affects work efficiency and system stability.

Thus, there is a need to develop a protection mechanism to enhance system stability, increase fault-analysis and fault-solving abilities and avoid continuous system crash during switching from FRB 3 to FRB 2.

### SUMMARY OF THE INVENTION

In the light of forgoing drawbacks, an objective of the present invention is to provide a method for detecting a switching failure applicable to the two fault resilient mechanisms FRB 2 and 3 defined under the IPMI architecture, such that continuous system crash can be avoided.

Another objective of the present invention is to provide a method for detecting a switching failure that records information about the failure of switching from the FRB 3 mechanism to the FRB 2 mechanism, providing users the ability to analyze and solve the failure.

Still another objective of the present invention is to provide a method for detecting a switching failure that achieves system stability with simple processes.

In accordance with the above and other objectives, the present invention proposes a switching failure detecting method applicable to a computer system having a base management controller (BMC), a basic input/output system (BIOS) and a central processing unit (CPU) under an intelligent platform management interface (IPMI). The method includes having the BMC to detect if the computer system is powered-on; enabling a fault resilient booting (FRB) 3 mechanism after the BMC detects that the computer system is powered-on; disabling the FRB3 and enabling a self-generated BMC-FRB2 mechanism when the BMC detects that the CPU starts to execute the BIOS; and disabling the self-generated BME-FRB2 mechanism and enabling an FRB2 mechanism if the BMC detects that the BIOS performs a system memory initialization and test process within a predetermined time period, or establishing and storing a failure record.

Moreover, in one embodiment of the method for detecting a switching failure of the present invention, the failure record is stored in a memory that is accessible by a BIOS program.

Moreover, in another embodiment of the method for detecting a switching failure of the present invention, a system rebooting process is further performed when the FRB 2 mechanism is not enabled by the BMC within the predetermined time.

Moreover, in still another embodiment of the method for detecting a switching failure of the present invention, the system is a blade server.

The method for detecting a switching failure of the present invention mainly solves the problem of failure to switch from FRB 3 to FRB 2 by establishing a failure record after a predetermined time has elapsed without the FRB 2 signal being generated and thereafter automatically rebooting the system. Thus, by the virtue of the present invention, the system stability is enhanced, fault-analysis and fault-solving abilities can be increased and continuous system crash can be avoided.

### BRIEF DESCRIPTION OF THE DRAWINGS

The present invention can be more fully understood by reading the following detailed description of the preferred embodiments, with reference made to the accompanying drawings, wherein:

FIG. 1 shows a basic structural block diagram required for a system that performs the method for detecting a switching failure of the present invention; and

FIG. 2 is an operational flowchart of the method for detecting a switching failure of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

It should be noted that the appended drawings are simplified to schematically illustrate the basic structure of the present invention. Thus, only those elements pertaining to the present invention are shown; the actual layout may be more complicated.

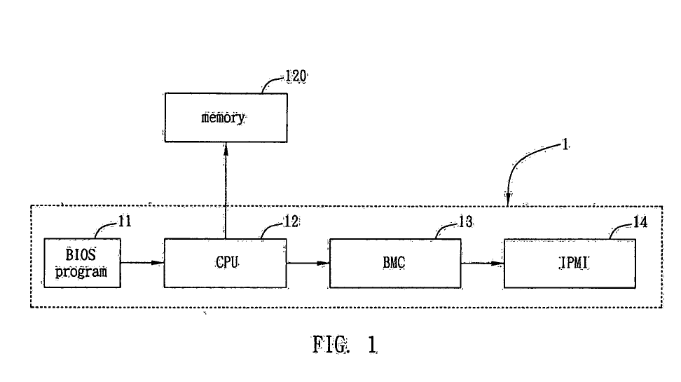

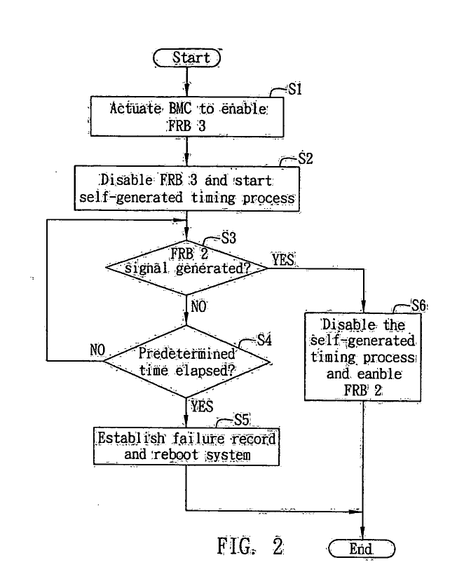

Referring to FIG. 1 and 2, FIG. 1 shows a basic structural block diagram required for a computer system that performs the method for detecting a switching failure of the present invention; FIG. 2 is an operational flowchart of the method for detecting a switching failure of the present invention. The method for detecting a switching failure of the present invention is applied to two fault resilient mechanisms, Fault Resilient Booting (FRB) 2 and FRB 3, under an Intelligent Platform Management Interface (IPMI) architecture, in order to avoid system crash due to switching failure from FRB 3 mechanism to FRB 2 mechanism in the IPMI architecture, and determine the problem of failure during switching from FRB 3 mechanism to FRB 2 mechanism.

The method for detecting a switching failure can be applied to a computer system 1, such as a blade server. The blade server will be used to illustrate this embodiment. As shown in FIG. 1, the blade server 1 includes a BIOS 11, a Central Processing Unit (CPU) 12, a Base Management Controller (BMC) 13, an IPMI 14 and a memory 120. The BIOS program 11 is used for performing a Power On Self Test (POST) task when the system is turned on so as to initialize the system. The CPU 12 is used to read the BIOS code stored in the BIOS 11 so as to execute driving and operating tasks. In this embodiment, these tasks refer to the POST tasks executed after the system is turned on. The BMC 13 and the IPMI 14 are electrically connected with each other to transmit system information of the blade server, allowing the BMC 13 to determine the overall status of the blade server. The memory 120 is used for storing a failure record established during POST when switching from the FRB 3 mechanism to the FRB 2 mechanism is unsuccessful, such that a user may be able to determine the fault. It should be noted that the blade server may include other functionalities and modules, but only those pertaining to the present invention are described for conciseness. Moreover, since a blade server is well known to those with ordinary skill in the art, so are the FRB 2 ad FRB 3 mechanisms, their specific structures and architectures will not be described in detail.

Now the operating procedures of the method for detecting a switching failure of the present invention is described with reference to FIG. 2 and in conjunction with the elements of FIG. 1. When the system is powered on, step S1 is executed. In step S1, after power is supplied, the BMC 13 receives a power supplying signal (i.e. is actuated) and enables a FRB 3 mechanism. Then, step S2 is performed.

In step S2, when the BIOS program has been successfully obtained by the CPU 12, the BMC 13 is notified (e.g. by asserting a signal pin) by the CPU to disable the FRB 3 signal and activate a self-generated timing process for counting a predetermined time. Then, step S3 is performed. The self-generated timing processing can be implemented via a software program or a hardware circuit.

In step S3, it is determined whether the BIOS 11 sends a FRB 2 signal to the BMC 13 for enabling a FRB 2 mechanism, if so, go to step S6; else, go to step S4.

In step S4, it is determined whether the predetermined time counted by the self-generated timing process is reached, if so, then go to step S5; else, return to step S3 to keep determining whether the FRB 2 signal is generated.

In step S5, since the BMC 13 has not received the FRB 2 signal from the BIOS 11 within the predetermined time, thus a fault may have occurred when switching from the FRB 3 mechanism to the FRB 2 mechanism, a failure record is established and stored in the memory 120, and a reboot operation is then performed. The method for detecting a switching failure then ends. A user who notices that the POST is not successful or the booting operation is unstable may then check the failure record stored in the memory 120 for debugging. The failure record is stored in a memory that can be accessed by the BIOS program.

In step S6, the self-generated timing process is disabled by the BMC and subsequent initialization can be performed by the CPU since after the system is turned on, the BMC 13 have successfully switched from the FRB 3 mechanism to the FRB 2 mechanism, which indicates that the BMC 13 can successfully communicate with the CPU 12 and that the memory in which the BIOS program is stored can be read. Furthermore, another timing process for the FRB 2 mechanism may be executed for detecting whether the initialization is successful.

Comparing to the prior art, the method for detecting a switching failure of the present invention mainly solves the problem of failure to switch from FRB 3 to FRB 2 by establishing a failure record after a predetermined time has elapsed without the FRB 2 signal being generated and thereafter automatically rebooting the system. Thus, by the virtue of the present invention, the system stability is enhanced, fault-analysis and fault-solving abilities can be increased and continuous system crash can be avoided.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for detecting a switching failure detecting applicable to a computer system having a base management controller (BMC), a basic input/output system (BIOS) and a central processing unit (CPU) under an intelligent platform management interface (IPMI), the method comprising the steps of:
having the BMC to detect if the computer system is powered-on;
enabling a fault resilient booting (FRB) 3 mechanism after the BMC detects that the computer system is powered-on;
disabling the FRB3 and enabling a self-generated BMC-FRB2 mechanism when the BMC detects that the CPU starts to execute the BIOS; and
disabling the self-generated BME-FRB2 mechanism and enabling an FRB2 mechanism if the BMC detects that the BIOS performs a system memory initialization and test process within a predetermined time period, or establishing and storing a failure record.

2. The method for detecting a switching failure of claim 1, wherein the failure record is stored in a memory that is accessible by a BIOS program.

3. The method for detecting a switching failure of claim 1 further comprising performing a system rebooting process when the FRB 2 mechanism is not enabled within the predetermined time period.

4. The method for detecting a switching failure of claim 1, wherein the computer system is a blade server.
